(19) United States
(12) Patent Application Publication
(10) Pub. No.: US 2003/0132220 A1
(43) Pub. Date: Jul. 17, 2003

(54) Direct probing temperature regulation and overheat protection system for immersion heater

(76) Inventors: Siu Yim Yung, Hong Kong (HK); Chi Cheong Hui, Hong Kong (HK)

Correspondence Address: Chi Cheong Hui, Room 1612, Grandtech Centre, 8 On Ping Street, Shatin, New Territories, HK

(21) Appl. No.: 10/043,854

(22) Filed: Jan. 14, 2002

(51) Int. Cl. H05B 1/02

(52) U.S. Cl. 219/494; 392/498

(57) ABSTRACT

A direct probing temperature regulation and overheat protection system for immersion heater includes a bimetal device adapted to receive thermal energy that is stored in the probe type temperature sensor. The bimetal device opens an electrical contact when the temperature of the bimetal device is reached. The displacement of the bimetal device that drives the electrical contact is a function temperature of the bimetal device that is a function of the resultant heat energy stored in the probe type temperature sensor. The probe type temperature sensor is immersed vertically in the operation liquid that gains heat from the heating element of the immersion heater. In the normal operating condition the displacement of the bimetal device is a function of heat gain from the operation liquid heat loss to surrounding and heat gain from the heating element. In the boil dry operating condition, the displacement of the bimetal device is mainly a function of heat gain from the heating elements that increase rapidly. In preferred embodiment, the construction and arrangement of the devices and the heating element form a thermal system that makes temperature regulation independent of the level of the operation liquid possible, the same thermal system also makes overheat protection possible.

### FIELD OF THE INVENTION

The present invention relates to a temperature regulation and overheat protection system for immersion heater and more specifically to a temperature regulation and overheat protection system for immersion heater that regulate the operating temperature and protect the immersion heater from overheating by direct temperature probing.

### BACKGROUND OF THE INVENTION

An appliance employing immersion heater commonly requires two types of controls. The first one is the temperature control that regulates the operating temperate of the appliance. The second one is overheat protection control that protects the appliance from overheating in case the appliance contains no liquid or the liquid level falls below the heating elements.

Various electromechanical or electronic devices can be used to perform temperature control. However, electromechanical devices are more commonly used due to their low cost and reliability.

There are two common types of electromechanical temperature control devices used in electric heating appliances.

The first type of electromechanical temperature control device is the capillary tube temperature control device in which some temperature sensing fluid is stored in a container that is connected to a small capillary tube. The volume of the temperature sensing fluid in the container expands and contracts according to the temperature. Due to the fact that temperature sensing fluid is incompressible, the change of volume of the temperature sensing fluid that flows into the small capillary tube due to temperature change is transformed into linear displacement; the smaller the cross section of the capillary tube the greater the linear displacement. Reaching a position of the desired temperature equivalence, an electrical contact will be opened. Since the container and the capillary tube fixture is an enclosed device, it can be immersed into the liquid so as to measure directly the liquid temperature.

The second type of electromechanical temperature control device is the bimetal temperature control device in which two metals with different coefficients of linear expansion are bound together to form a bimetal strip. The bimetal strip is thermally coupled to a probe with enough heat capacity; it bends according to the temperature of the probe, or the displacement due to the bending of the bimetal strip has a temperature equivalence. Reaching a position of the desired temperature equivalence, an electrical contact will be opened. Since the displacement of the bimetal strip is small, it can be placed closely to the contacts that are electrically active; they are used to measure the temperature of the heating plates that couple to the heating elements.

Immersion heater type appliances mostly use the first type of electromechanical temperature control devices. Practically, most immersion heater temperature control designs use two capillary tube temperature control devices with both devices immersed in the liquid, one for the regulation of the operation liquid, while the other one for the protection of the appliance from overheating. The operating temperature of the liquid is measured directly; it can be regulated precisely.

Hot plate type appliances mostly use the second type of electromechanical temperature control device. Practically, most hot plate temperature control design put the bimetal temperature control device and the heating element inside the die casting of the hot plate so that they together form an integral part. The operating temperature of the hot plate instead of the food being cooked is measured; the desired cooking temperature cannot be regulated precisely.

The capillary tube temperature control device costs much higher than the bimetal temperature control device owing to the complexity of the construction. However the simplicity, reliability as well as the low cost of the bimetal temperature control device makes it an attractive device for immersion heater temperature control if it can regulate the temperature precise enough by measuring the operation liquid temperature directly. It would be better if the bimetal temperature control device can provide overheat protection.

An Object of the invention is therefore to provide a direct probing bimetal temperature regulation and overheat protection system for immersion heaters such that lower cost is possible without sacrificing the precision of temperature regulation and overheat protection.

### SUMMARY OF THE INVENTION

The invention provides a direct probing bimetal temperature control system for immersion heater adapted to receive the temperature signal which is generated by the probe type temperature sensor, wherein the said probe type temperature sensor detects the temperature of the operation liquid by immersing in it. The said operation liquid receives heat energy from the heating element that is immersed in it, the said heating element is an electrical heating device that transforms electrical energy to heat energy by applying a current flow through a resistance. The said operation liquid may be oil, water or steam which transfers heating energy to food by conduction.

The said direct probing bimetal temperature control device for immersion heater consists of a bimetal strip that is thermally coupled to the said probe type temperature sensor, the said bimetal strip is constructed by binding two metal strips with different coefficients of linear expansion. The said bimetal strip bends in the direction that is perpendicular to the said bimetal strip according to the temperature of the said bimetal strip. With one end of the said bimetal strip fixed and thermally coupled to the said probe type temperature sensor, the relative position of the movable end of the said bimetal strip is a temperature equivalent quantity.

The said direct probing bimetal temperature control device for immersion heater also consists of an electrical contact which controls the electric current flowing through the electrical heating element. Opening the said contact stops the current from flowing through the said electrical heating element and closing of the said contact allows electric current to flow through the said electrical heating element. The movement of the said movable end of the said bimetal strip opens the said contact when the position equivalent temperature is reached and closes the said contact when the temperature falls below.

The said position equivalent temperature of the said bimetal strip is maintained by the heat transferred to it from the said probe type temperature sensor, wherein the said probe type temperature sensor obtains the heat energy from the said operation liquid by immersing into it. The displacement of the said bimetal strip is a function of temperature of the said bimetal strip developed from the energy supplied by the said probe type temperature sensor. Owing to the heat lost to surrounding and gain from the heat source, the said displacement is a function of the resultant heat energy stored in the said probe type temperature sensor.

In the normal operating condition of the said immersion heater, the said heating element and the said probe type temperature sensor are immersed in a vessel containing the said operation liquid.

The said probe type temperature sensor are placed vertically in the said vessel so that the higher the level of the said operation liquid the larger the immersed portion and the smaller the exposed portion of the said probe type temperature sensor. The result of lowering the level of the said operation liquid is less heat is gained by conduction from the said operation liquid and more heat is lost to the surrounding by radiation.

The said probe type temperature sensor are placed adjacent to the said heating elements so that the lower the level of the said operation liquid the more heat is gained by radiation from the exposed portion of the said heating element.

The heat capacity of the said probe type temperature sensor is also significant to its performance since it should provide enough energy for the bending of the said bimetal strip. However the higher the said heat capacity the slower the response to the change of the temperature of the said operation liquid.

In summary, the said displacement is a function of the heat capacity of the said probe type temperature sensor, the heat gain by conduction from the said operation liquid at the immersed portion of the said probe type temperature sensor, the heat gain from the exposed portion of the said heating element and the heat loss by radiation to surrounding at the exposed portion of the said probe type temperature sensor.

Taking the above factors into account, the arrangement of the said heating element and the physical construction of the said probe type temperature sensor can be so adjusted that the level of the said operation liquid could have little effect on the said displacement. This arrangement makes the said displacement a function of the temperature of the said operation liquid.

In the boil dry operating condition of the said immersion heater, the said heating element and the said probe type temperature sensor are placed in a vessel with no said operation liquid or the level of the said operation liquid is below the said heating element. The said displacement is a function of the heat gain from the whole portion of the said heating element and the heat loss by radiation to the surrounding at the whole portion of the said probe type temperature sensor.

During the said boil dry operating condition, the major heat gain is from the said heating element that increases rapidly. Owing to the high heat capacity of the said probe type temperature sensor the temperature will be regulated to a higher level that effectively protects the appliance from overheating.

### BRIEF DESCRIPTION OF THE DRAWINGS

Embodiments of the invention will now be described by way of example only and with reference to the accompanying drawings, in which:

FIG. 1 shows a block diagram of the energy flow of the direct probing temperature regulation and overheat protection system for immersion heater employing the present invention;

FIG. 2 shows the construction of the bimetal switch and probe type temperature sensor for direct probing temperature regulation and overheat protection system employing the present invention;

FIG. 3 shows the construction of the preferred embodiment employing the present invention;

FIG. 4a, 4b, 4c show the curves of temperature regulation of the preferred embodiment employing the present invention

FIG. 5 shows the curve of overheat protection in the boil dry operating condition of the preferred embodiment employing the present invention.

### DETAILED DESCRIPTION OF THE PREFERRED EMBODIMENT

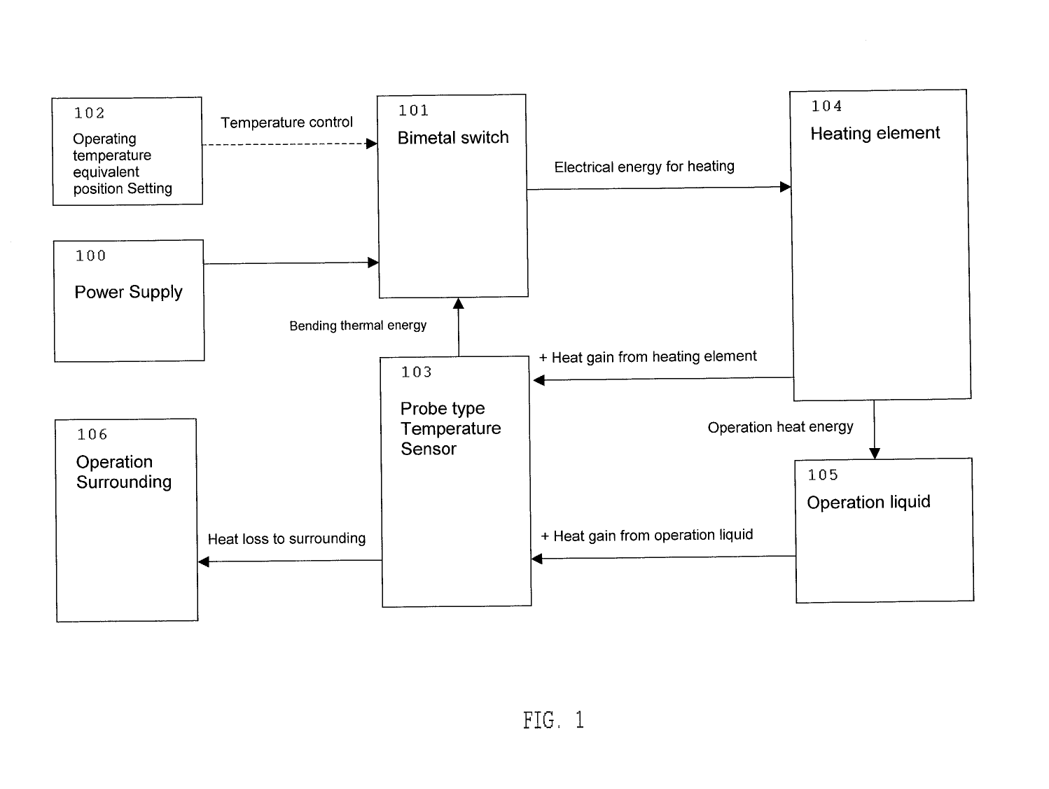

FIG. 1 show a block diagram of the energy flow of the direct probing temperature regulation and overheat protection system for immersion heater employing the present invention,

In the embodiment, the operating heat energy of the immersion heater that is generated by the heating element 104 is used to heat up the operation liquid 105 by immersing in it. The operation liquid 105 may be oil, water, steam or any suitable liquid that transfers heat energy to food by conduction.

The said heating element 104 converts electrical energy to operating heat energy. The electrical energy is controlled by a bimetal switch 101 which turns on or off an electrical contact by referring to an operating temperature equivalent position setting 102.

The said bimetal switch 101 turns on or off the said electrical contact by bending a bimetal strip which bending thermal energy is obtained from a thermally coupled probe type temperature sensor 103. The said probe type temperature sensor 103 stores energy which is a function of the heat gain from the said heating element 104, the heat gain from the said operation liquid 105 and lost to the operation surrounding 106.

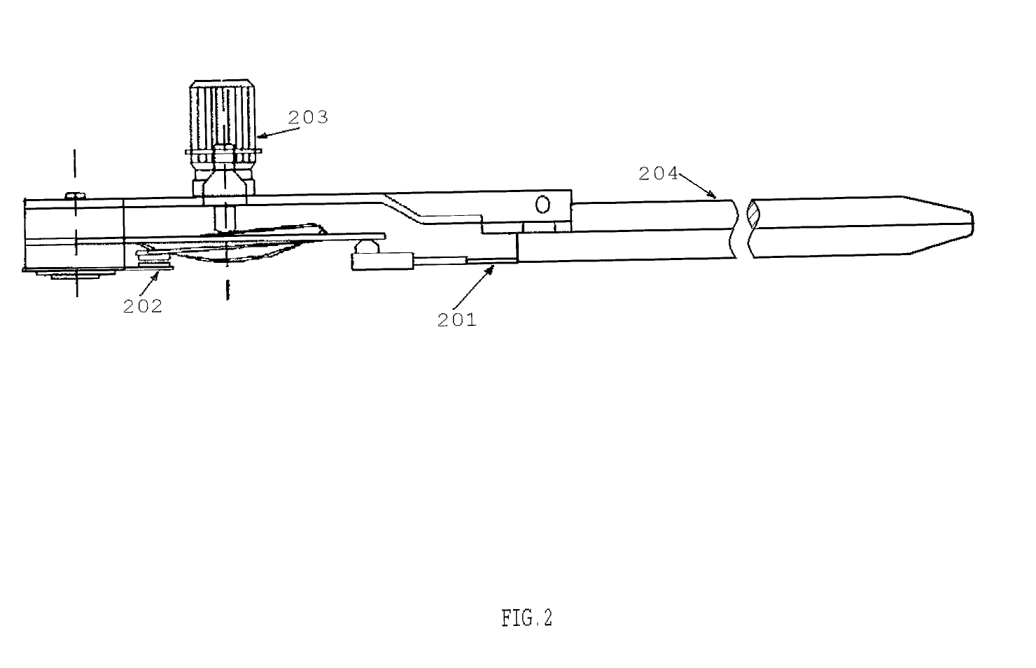

FIG. 2 shows the construction of the bimetal switch and probe type temperature sensor for direct probing temperature regulation and overheat protection system employing the present invention.

The bimetal strip 201 is thermally coupled to the probe type temperature sensor 204 which heat capacity is sufficient to store up the bending thermal energy such that the bimetal strip 201 bends according to the temperature of the probe type temperature sensor 204.

The operating temperature of the immersion heater is controlled by an operating temperature equivalent position setting 203, reaching the desired temperature the bimetal strip 201 bends to a position that effectively switches off the electrical contact 202 and disconnects the power supply to the heating element 104. After cooling down the bimetal strip 201 retreats to a position such that the power supply to the heating element 104 is switched on again.

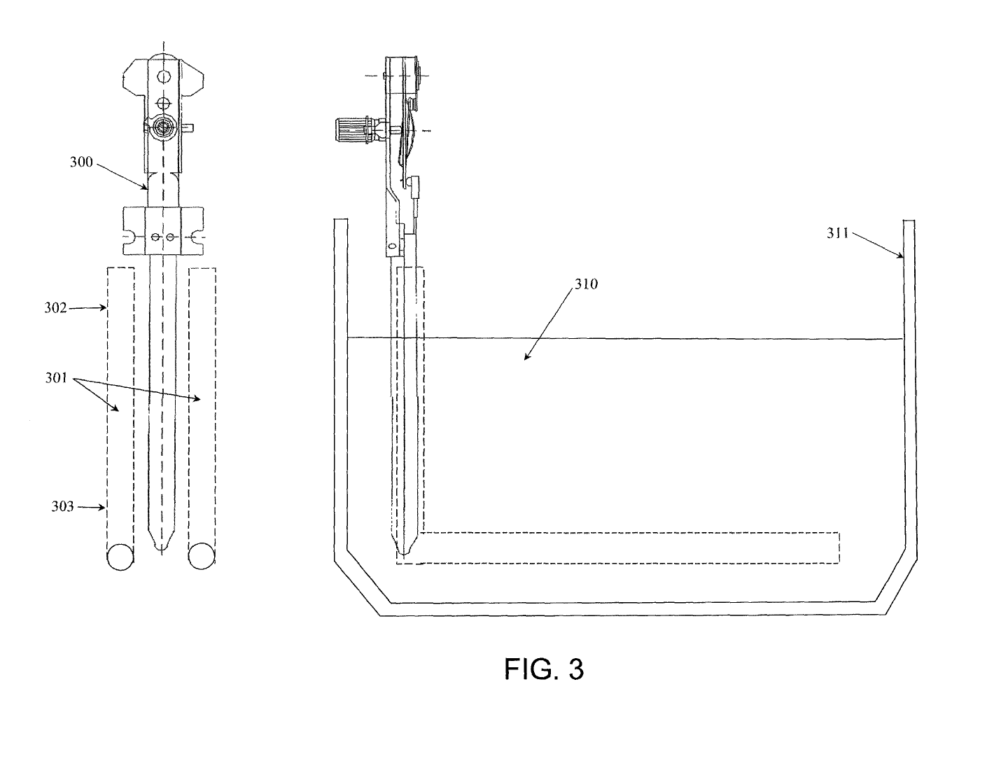

FIG. 3 shows the construction of the preferred embodiment employing the present invention.

A vessel 311 contains the operation liquid 310 that transfers heat energy to food by conduction. The operation liquid 310 is heat up by the heating element 301 that is immersed in it. The probe type temperature sensor 300 is immersed vertically into the operation liquid 310 such that it receives energy from the heating element 301, the operation liquid 310 and loses energy to the operation surrounding.

The volume of the operation liquid 310 varies depending of the cooking requirements such that the level of the operation liquid 310 may vary from the minimum level 303 to the maximum level 302.

In the preferred embodiment, the probe type temperature sensor 300 is placed adjacent to the heating element 301, the higher the level of the said operation liquid 310 the larger the immersed portion and the smaller the exposed portion of the said probe type temperature sensor 300.

By lowering the level of the operation liquid 301 less heat is gained by conduction from the said operation liquid 310, more heat is lost to the surrounding by radiation and more heat is gained by radiation from the exposed portion of the said heating element 301.

The probe type temperature sensor 300, the heating element 301, the operation liquid 310 and the operation surrounding 106 forms a thermal system, by arranging the components of the thermal system the effect of the level of the operation liquid 310 to the bending thermal energy can be minimized.

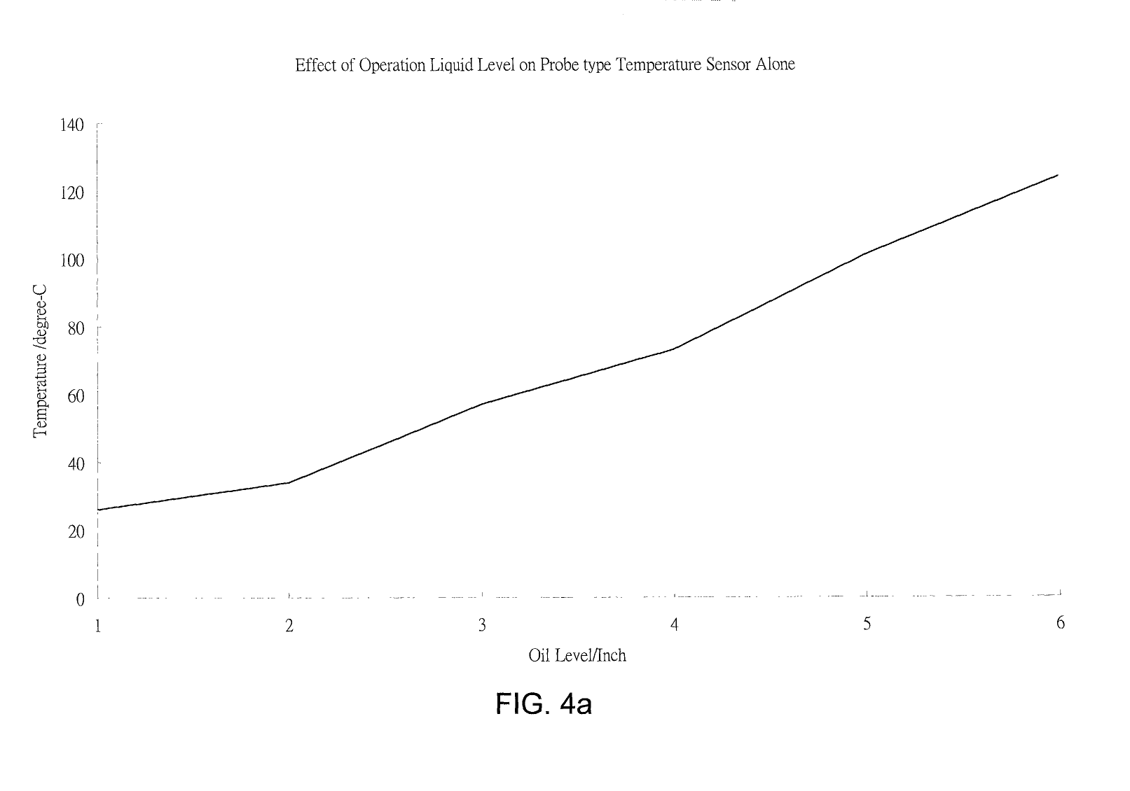

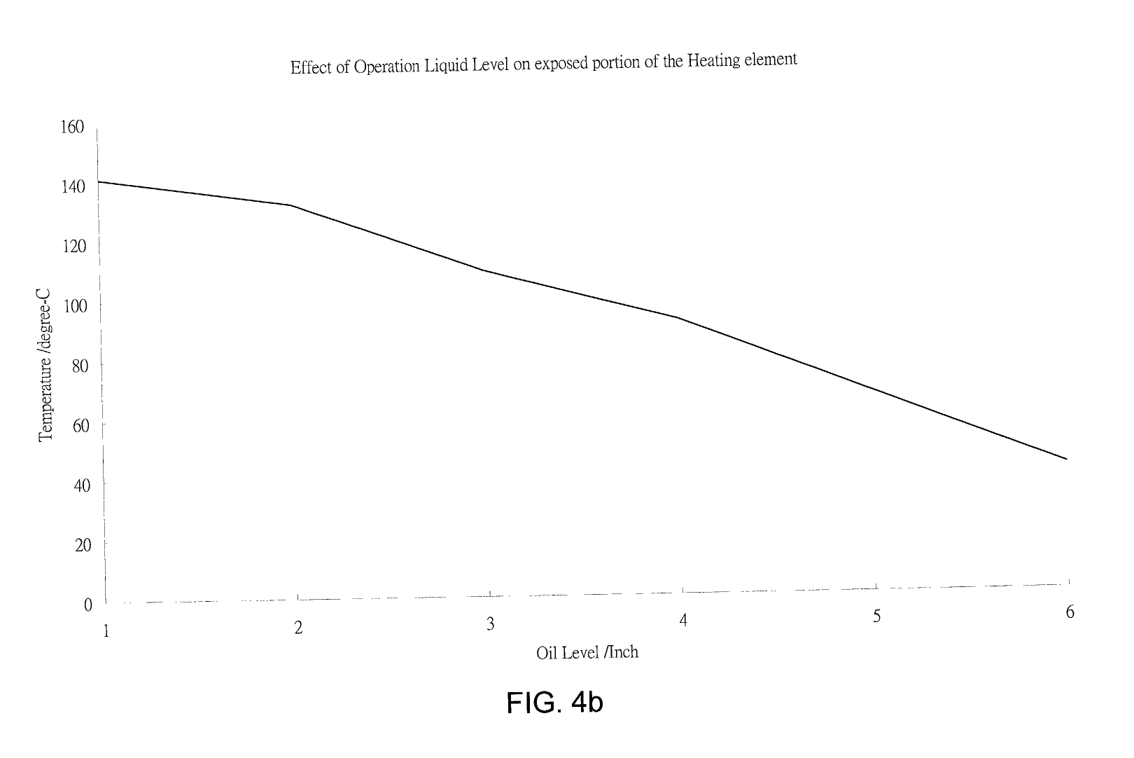

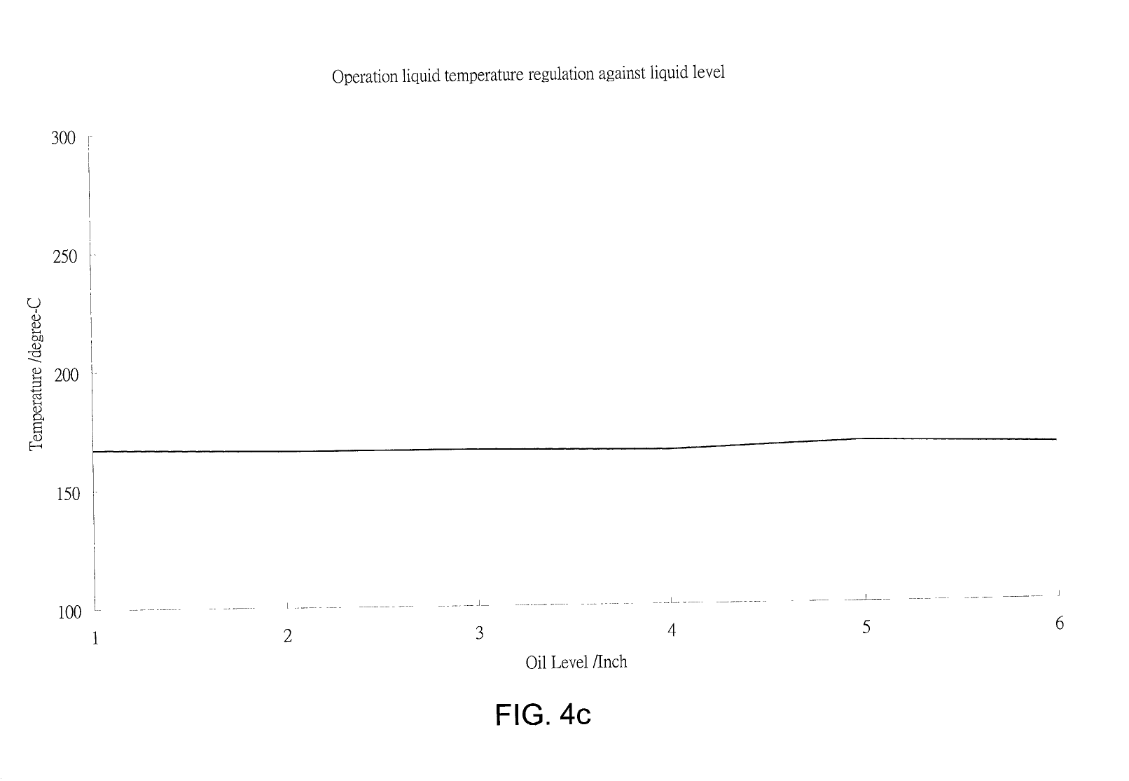

FIG. 4a shows the curve of the temperature of the probe type temperature sensor 300 against the level of the operation liquid 310 while the probe type temperature sensor 300 is placed alone in an operation liquid 310 of constant temperature.

FIG. 4b shows the curve of the temperature of the exposed portion of the heating element 301 against the level of the operation liquid 310 while the heating element 301 is immersed in an operation liquid 310 of constant temperature.

FIG. 4c shows the curve of the temperature regulation of operation liquid 310 when the probe type temperature sensor 300 is immersed adjacent to the heating element 301. The arrangement neutralizes the effect of level of the operation liquid 310 on the temperature of the probe type temperature sensor 300. Temperature regulation of the operation liquid 310 by employing the present invention is achieved.

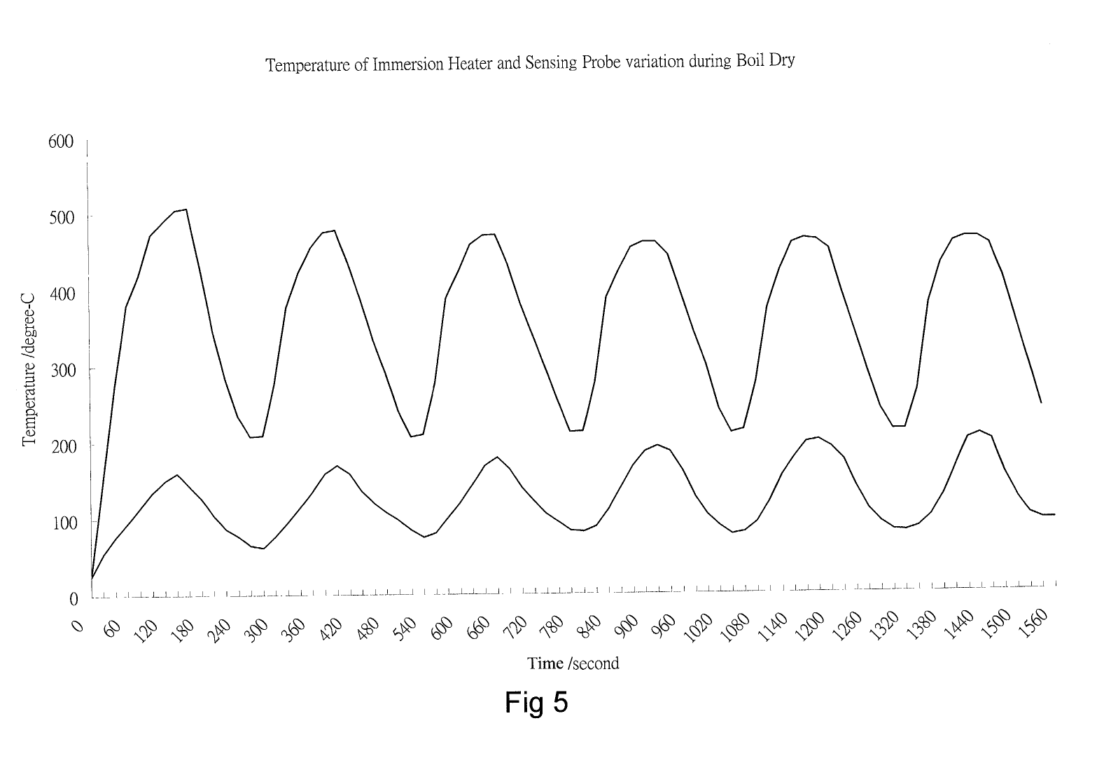

FIG. 5 shows the curve of overheat protection in the boil dry operating condition of the preferred embodiment employing the present invention. In the boil dry operation condition, the heating element 301 heats up rapidly, heat is transferred to the probe type temperature sensor 300. After reaching the equivalent temperature that corresponds to the desired operation liquid temperature setting, the electrical contact 202 is switched off, the heating element cools down until the electrical contact 202 is switched on again. Owing to the heat capacity of probe type temperature sensor 300, the probe type temperature sensor 300 cools down at slowly, the hysteresis effect forces the temperature of the heating element 301 oscillates within a temperature range.

What is claimed is:

1. A direct probing temperature regulation and overheat protection system for immersion heaters comprising a bimetal device arranged to receive the bending thermal energy from a probe type temperature sensor that is immersed in an operation liquid that receives heat energy from the heating element, the said bending thermal energy provides mechanical energy to the said bimetal device such that its moving portion displaces according to its temperature, the said bimetal device is further arranged to control the temperature of the said operation liquid by switching on or off the power supply of the said heating element after the temperature of the said bimetal device falls below or rises above a referent temperature.

2. The direct probing temperature regulation and overheat protection system for immersion heaters of claim 1 wherein the said probe type temperature sensor are built using material with heat capacity that stores energy sufficient enough to provide said bending thermal energy.

3. The direct probing temperature regulation and overheat protection system for immersion heaters of claim 1 wherein the said probe type temperature sensor are built using material with heat capacity that provides hysteresis effect to the said switching on or off the power supply of the said heating element.

4. The direct probing temperature regulation and overheat protection system for immersion heaters of claim 1 wherein said bending thermal energy is a function of the resultant heat energy stored in the said probe type temperature sensor.

5. The direct probing temperature regulation and overheat protection system for immersion heaters of claim 1 wherein said operation liquid transfers energy to food by conduction.

6. The direct probing temperature regulation and overheat protection system for immersion heaters of claim 4 wherein said resultant heat energy is a thermal system that gains and loses heat energy.

7. The direct probing temperature regulation and overheat protection system for immersion heaters of claim 6 wherein said thermal system gains heat energy from the said operation liquid.

8. The direct probing temperature regulation and overheat protection system for immersion heaters of claim 6 wherein said thermal system gains heat energy from the said heating element.

9. The direct probing temperature regulation and overheat protection system for immersion heaters of claim 6 wherein said thermal system loses heat energy to the operation surrounding.

10. The direct probing temperature regulation and overheat protection system for immersion heaters of claim 6 wherein said thermal system arranged to correlate the said resultant heat energy with the temperature of the said operation liquid, said to minimize the effect of the level of the operation liquid to the said resultant heat energy by balancing the heat gain from the said heating element with the heat loss to said operation surrounding.

11. The direct probing temperature regulation and overheat protection system for immersion heaters of claim 10 wherein said thermal system further arranged to correlate the said resultant heat energy with the temperature of the said heating element while the said operation liquid is absent, said to prevent the temperature of the said heating element from overheating.
